(19) United States
(12) Patent Application Publication
(10) Pub. No.: US 2025/0079477 A1
(43) Pub. Date: Mar. 6, 2025

(54) BIPOLAR PLATE FOR AN ELECTROCHEMICAL SYSTEM

(71) Applicant: Reinz-Dichtungs-GmbH, Neu-Ulm (DE)

(72) Inventors: Claudia KUNZ, Ulm (DE); Bernadette GRÜNWALD, Ulm (DE); Rainer GLÜCK, Dornstadt-Tomerdingen (DE)

(21) Appl. No.: 18/821,906

(22) Filed: Aug. 30, 2024

(30) Foreign Application Priority Data
Sep. 1, 2023 (DE) 20 2023 105 027.1

(51) Int. Cl. H01M 8/026

(52) U.S. Cl. CPC H01M 8/026

(57) ABSTRACT

A bipolar plate for an electrochemical system comprising a stack of bipolar plates, the bipolar plates having first and second separator plates. The first and second separator plates each comprise at least two through-openings for passing a reaction medium, at least one distribution region, and a flow field. The distribution region fluidly connects one of the through openings to the flow field. The distribution region has channels separated by webs for guiding reaction media. Each channel has a channel bottom and flanks on both sides of the channel bottom. A first width extending between transition regions of flanks on each side of a channel bottom is more than three times as large as a second width indicating a width of the channel base. The channel base of the first separator plate contacts the back of the second separator plate in an unassembled state of the bipolar plate.

### CROSS-REFERENCE TO RELATED APPLICATION

This application claims priority to German Utility Model Application No. 20 2023 105 027.1, entitled “BIPOLAR PLATE FOR AN ELECTROCHEMICAL SYSTEM”, filed Sep. 1, 2023. The entire contents of the above-identified application is hereby incorporated by reference for all purposes.

### TECHNICAL FIELD

The present disclosure relates to a bipolar plate for an electrochemical system. The electrochemical system may in particular be a fuel cell system, an electrochemical compressor, an electrolyser, or a redox flow battery. It can comprise a large number of such separator plates or bipolar plates.

### BACKGROUND AND SUMMARY

Known electrochemical systems of the aforementioned type normally comprise a stack of electrochemical cells, which are separated from one another by bipolar plates. Such bipolar plates can be used, for example, to establish electrical contact with the electrodes of the individual electrochemical cells (such as fuel cells) and/or to electrically connect adjoining cells (series connection of the cells). Typically, the bipolar plates are formed of two joined individual plates, which are also referred to as separator plates within the scope of the present document. The single plates may be joined together in a materially bonded manner, for example by one or more welded joints such as laser-welded joints.

The bipolar plates or the individual plates can each have or form structures of the type explained below, which are set up, for example, for supplying the electrochemical cells arranged between adjacent bipolar plates with one or more media and/or for removing reaction products. The media may be fuels (for example hydrogen or methanol), reaction gases (for example air or oxygen) or coolants. Moreover, the bipolar plates can be designed to pass on the waste heat that is generated during the conversion of electric or chemical energy in the electrochemical cell and to seal the different media channels or cooling channels with respect to one another and/or with respect to the outside.

Moreover, the bipolar plates usually include at least one respective through-opening, through which the media and/or the reaction products can be conducted to the electrochemical cells arranged between adjoining bipolar plates of the stack or away therefrom. The electrochemical cells typically also include in each case one or more membrane electrode assemblies (MEAs). The MEA can have one or more gas diffusion layers (GDLs), which are usually oriented towards the bipolar plates and are designed as a metal or carbon fleece, for example.

Channels within the separator plates and thus the bipolar plate, which are separated from each other by webs, can be provided as structures for media supply and/or media routing. The channels, which can be embossed in the form of grooves, for example, can provide flow paths for the typically liquid or gaseous media.

Typically, each separator plate has an active region with channels for guiding a reaction medium and/or reaction products along the outside of the bipolar plate. This active region is opposite an MEA. The active region can also be referred to as a flow field or comprise a flow field.

The active region is connected to one of the through-openings in a fluid-conducting manner via a so-called distribution region and is fed through this. Reaction media and/or reaction products can be fed from the active region via a further distribution region, which can also be referred to as a collection region, to a further through-opening for removal. The distribution regions also typically have certain separate channels.

On the inner sides of two separator plates facing each other, which are surrounded by a respective bipolar plate, the above-mentioned channel-web structures of the flow field and of the at least one distribution region form complementary web-channel structures. These span an optional flow region for optional coolant routing in the interior of the bipolar plate.

When forming a ready-to-use stack, a membrane electrode assembly is provided between adjacent bipolar plates, which membrane electrode assembly, in the flow region, separates the channels for the passage of the reaction medium in a first bipolar plate from the channels for the passage of another reaction medium in a second bipolar plate, said second bipolar plate being separated from the first bipolar plate only by the membrane electrode assembly. The membrane electrode assembly, typically abbreviated as MEA, usually extends beyond the active region into the distribution region(s).

In their active region, MEAs usually comprise the actual proton-conducting membrane, electrodes applied to it and catalyst layers on which conductive and gas-permeable layers, so-called gas diffusion layers (GDLs), are applied. In its edge region, the MEA usually comprises a polymer-based film material that encloses the active region and overlaps in a narrow overlap region with the materials forming the active region or a part thereof. In a stack of an electrochemical system, the MEA defines the spacing between the separator plates. At the same time, the gas diffusion layers (GDL) of the MEA exhibit relatively large fluctuations in thickness.

A space between bipolar plates is therefore usually provided in the thickness direction of the stack, so that there is sufficient space in the active region to accommodate the relevant section of the MEA on the one hand and just enough space for defined compression of this section of the MEA on the other. As a result, there is sometimes more space in the distribution regions than is absolutely necessary for their function. A thicker-than-average MEA in the active region therefore results in a large gap in the distribution regions, while a thinner-than-average active region of the MEA results in little or no gap in the distribution regions.

In conventional plates, the bipolar plates are designed in such a way that their separator plates come to lie on top of each other in sections both in the active region and in the distribution regions and are welded together at least in sections in these regions. However, pressure fluctuations of the coolant passing between the bipolar plates of a stack cause movements of the separator plates relative to each other and expose the connections between the separator plates of a bipolar plate, in particular welded connections in the distribution regions, to dynamic pressure fluctuations and loads. These can cause the welded joint to break. This applies in particular if the connections are already exposed to increased loads due to variations in the thickness of the MEAs.

As a result, undefined media flows can occur through the interior of the bipolar plate, which leads to pressure loss and therefore efficiency losses. In addition, the separator plates as such can also become perforated in the region of the welded joints, which jeopardizes the operational capability and in particular the operational safety of the bipolar plate and the higher-level electrochemical system.

One object of the present disclosure is therefore to provide a bipolar plate with which thickness fluctuations of an MEA can be compensated while ensuring improved efficiency and operational reliability.

This object is at least partially achieved by the subject matter of the present disclosure.

Accordingly, a bipolar plate is proposed for an electrochemical system comprising a stack of several bipolar plates, in particular several bipolar plates according to the present disclosure, in particular for a fuel cell system, an electrochemical compressor, an electrolyzer or a redox flow battery.

The bipolar plate comprises a first separator plate and a second separator plate, the rear sides of which are opposite each other and the front sides of which face away from each other. The first and second separator plates may be connected to each other, for example, welded, according to embodiments, but not within their distribution regions.

The first and second separator plates each have:
at least two through-openings for passing a reaction medium through the respective separator plate;
and on their respective front sides: at least one distribution region and a flow field, the distribution region in particular connecting at least one of the through-openings to the flow field in a fluid-conducting manner;
a respective distribution region having channels for guiding one of the reaction media along a respective longitudinal axis of the channels, the channels being separated from one another by webs and each having a width extending parallel to a plate plane of the bipolar plate and orthogonal to the longitudinal axis of the channels,
wherein each channel has a channel bottom with a channel base, in particular in the middle, and has flanks on both sides of the respective channel bottom, which connect the channel bottom to a respective web.

The flanks have a first radius in a first transition region to a respective web and each channel has a first width dimension which extends between the first transition regions of the bilateral flanks and, in particular, the ends of these first transition regions that face one another.

In addition, each channel has a second width dimension which indicates a width of the channel base, wherein at least in the case of the first separator plate the channel base contacts the second separator plate on the rear side in an unassembled state of the bipolar plate in the stack and/or wherein the channel base forms a deepest region of the channel.

It is provided that the first width dimension of at least the first separator plate is more than three times, optionally more than five times, more than six times, more than seven times or more than eight times as large as the second width dimension.

With the bipolar plate disclosed herein and in particular the ratios of the first and second width dimensions, the bipolar plate can have a specifically defined elasticity even in the presence of contact between the separator plates in order to at least partially compensate for variations in the thickness of the MEA. In other words, the geometric features disclosed herein can be used to provide an elasticity reserve within the bipolar plate in one thickness direction of the MEA.

The contact between the separator plates that is nevertheless provided enables a defined flow of media and reaction products, especially coolant, which improves efficiency. In particular, this contact and thus the defined guidance can be maintained at least in certain regions by utilizing the structurally increased elasticity, even with varying thicknesses of the MEA. Additionally or alternatively, the increased elasticity makes it possible to reduce or even dispense with weld seams connecting the separator plates. As a result, these cannot tear open, especially if the separator plates are perforated locally. This increases operational safety.

The separator plates can be arranged adjacent to each other in a direction perpendicular to the plate plane of the bipolar plate. The plate plane of the bipolar plate can run parallel to a plane of the respective separator plates. This can be a center plane that lies between the two separator plates and/or their respective plate planes and/or a plane within which the separator plates touch each other.

Similarly, a plate plane of the bipolar plate considered herein can be a flat surface plane of one of the separator plates or a plane parallel to it. In a manner known per se, the flat surface plane can be defined, for example, by an edge of the separator plate or by those flat regions of the separator plate which are not deformed as a result of an embossing or deep-drawing process to form the web-channel structures or beads described herein. On the one hand, the flat surface planes can run in the neutral fibers of the corresponding sections of the separator plates; on the other hand, it is also possible to consider the surfaces of the relevant sections of the plates as flat surface planes. With the latter approach, however, it must be ensured that the material thickness of only one of the two separator plates considered is taken into account for distances or similar.

When viewed from above on the bipolar plate, the through-openings of the separator plates can be aligned in pairs. For example, two different reaction media can be fed or discharged via the through-openings. In particular, however, the separator plates can each have at least six through-openings through which two different reaction media and a cooling fluid can be fed in and also discharged again.

Depending on the direction of flow, i.e. flow direction to or from the through-opening or the flow field, the distribution region can also function as a collection region of the type described above. The flow field and the at least one distribution region of a respective separator plate can overlap at least partially with the corresponding flow field and at least one distribution region of the corresponding other separator plate and/or lie opposite them.

The flow field can be characterized, for example, by the fact that all the webs and channels it comprises are straight and run parallel to each other and parallel to a main flow direction through the flow field. Alternatively, the webs and channels can also be wave-shaped and run next to each other with the same wave form and along the main flow direction (or also a main flow axis).

In addition or alternatively, the flow field can be characterized by the fact that it lies within an MEA reinforcement edge and, in particular, is surrounded and/or framed by it at least in sections. However, in some cases, the MEA reinforcement edge is not opposite the flow field itself, but the actual active region of the MEA, for example, in the form of its electrolyte membrane. By way of example, reference is made to DE 20 2020 106 459 Ul and in particular to the figure labeled 3B, which shows an MEA with a reinforcement edge framing an active region of the MEA. The present application does not contain such a figure designated 3B.

The channels of a respective distribution region can be in the form of grooves that are made in the respective separator plate, for example, embossed grooves. The channels can be separated from each other by webs which protrude from the bipolar plate in the direction of an outer side of the bipolar plate and/or relative to the channels and in particular a channel base. The channels in the distribution region can run parallel to each other, at least in sections, at an angle, curved with different radii or arranged completely randomly. In particular, the channels of the distribution region of a separator plate under consideration can run parallel to each other over large regions of the distribution region. However, when the structures of a distribution region are projected into a common plane with the array of channels of the neighboring distribution region of the other separator plate of the bipolar plate, they can intersect, for example at a positive angle. It is also possible that, at least in one of the two separator plates, the distribution region is divided into different sub-regions in which, for example, the angles of extension of the webs and/or channels differ from one another. Channels and/or webs of the distribution region can also have interruptions and/or depressions.

Each channel can have a channel bottom with a channel base, whereby the channel base forms a deepest region of the channel. A depth axis and/or depth dimension of a respective channel can run perpendicular to the plate plane of the bipolar plate and/or from a separator plate comprising the channel. Additionally or alternatively, the depth axis may be orthogonal to a longitudinal channel axis and/or any width dimension mentioned herein.

In general, any width dimension mentioned herein can be aligned according to the aforementioned width or a corresponding width axis, i.e. in particular parallel to a plate plane of the bipolar plate and orthogonal to a longitudinal axis of the channel. A channel longitudinal axis can be an axis along which a fluid flows through a respective channel. It does not necessarily have to be a continuous straight axis. For example, the longitudinal axis of any channel described herein may be curved one or more times, at least in sections.

The channel bottom can be curved, rounded, trapezoidal or otherwise uneven, at least in sections. A plane considered below containing the channel bottom at least in points can, for example, form a center plane of a corresponding curvature, bend or non-planar shape of the channel bottom. In this case, the plane can, for example, contain at least two locations or points on the channel bottom at which it intersects the channel bottom. In particular, such a plane can contain at least the channel base and/or run tangentially to it. In the latter case, it can also contain at least one location of the channel bottom in the form of the channel base due to a corresponding at least point-like contact with the channel or channel base.

However, the channel base can also comprise more than one location, for example if this is formed as a kind of depth plateau of the channel, as is possible according to embodiments.

Any plane containing the channel bottom at least at certain points can run essentially parallel to a plane of the webs or even the web crests. The web crests can form the highest regions of the webs when viewed along the depth axis, for example. Optionally, a plane containing the channel bottom at least at certain points and in particular running tangentially to the channel base can run parallel to a plane containing the webs or at least web crests, or at an angle to the latter plane, the angle being, for example, less than 40°, less than 30° or less than 20°. Additionally or alternatively, a plane containing the channel bottom at least at certain points and in particular running tangentially to the channel base can run parallel to a plate plane of the bipolar plate.

The flanks, which connect the channel bottom to an adjacent web in each case, cannot, however, run parallel to a plate plane of the bipolar plate and/or to a plane containing the webs or at least web crests. Optionally, they can run at a greater angle, for example at least 1.5 times or twice the angle, to at least one or both of these planes than a plane containing the channel bottom at least at certain points and in particular running tangentially to the channel base. Additionally or alternatively, an angle between a depth axis mentioned herein and the flanks may be smaller, for example at least 1.5 times or twice smaller, than an angle between the depth axis and a plane containing the channel bottom at least at certain points and in particular extending tangentially to the channel base.

In general, the channel bottom can be rounded and/or curved throughout, for example. Optionally, the channel base can form the lowest point of a curvature and/or rounding of the channel bottom. Alternatively or additionally, the rounding or curvature can be mirror-symmetrical around the channel base. The channel bottom can also be trapezoidal, for example, whereby the channel base can define a deepest region, in particular a floor line, of the trapezoidal shape. The trapezoidal shape can be characterized by essentially straight sections that converge at an angle to each other and optionally at the channel base.

Any shape of the channel bottom and/or the channel and/or the webs mentioned herein may be viewed in a cross-section, the cross-sectional plane being perpendicular to the longitudinal axis of the channel.

The flanks can be inclined and/or shaped in opposite directions. In particular, they can be inclined and/or shaped in the opposite direction relative to a plane containing the channel base and/or the longitudinal axis of the channel. For example, they can be inclined and/or shaped mirror-symmetrically in relation to this plane.

The webs or at least the web crests can be flat. Optionally, they can be less pronounced and/or less rounded and/or less trapezoidal than the channel bottom. The webs and the channel bottom can be spaced apart from each other by the flanks, especially along the depth axis. In general, the webs can define and/or include plateau-like protrusions.

In principle, the first transition region can contain parts of both a web and a flank that merges into it. The first transition region can be limited by one end of a web that faces an adjacent flank. This end can be characterized by an incipient drop in height compared to the otherwise plateau-like extension of the webs. In other words, the transition region can begin when there is a drop in the height of the webs and/or end when a constant height level of the webs is reached.

Additionally or alternatively, the first transition region can be limited by a position at which the flanks are straight. In other words, the first transition region can end or begin when the flanks run in a straight line for the first time, for example from the perspective of a neighboring web. If the flanks are continuously curved, the first transition region can be limited by an inflection point of the flanks, in particular by an inflection point closest to an adjacent web.

In summary, the first transition region can extend between a location of an incipient height drop or an incipient height stabilization of a web and a location of an incipient straightening or an inflection point of a flank. It goes without saying that webs and flanks adjacent to each other and connected by the transition region are considered. The locations mentioned here may correspond to or form first or second transition points of the type described below.

The first width dimension can be measured between those locations of the bilateral flanks of a channel where the flanks merge into the first transition region. As described above, these locations can each include a turning point or a straight flank section that begins for the first time, for example starting from an immediately adjacent web. Additionally or alternatively, these locations can form mutually facing ends of the first transition regions on both sides. The arrangement of the mutually facing ends can include or result from the fact that the flanks run towards each other in the region of the corresponding locations. Optionally, these mutually facing ends can be closer to each other, viewed in a width direction, than the corresponding other ends of the first transition region, at which the first transition region merges into the webs and, in particular, web plateaus. These ends can be understood as ends facing away from each other.

Because the first width dimension is significantly larger than the second width dimension according to the present disclosure, an elasticity reserve is provided despite the intended contact between the separator plates. In particular, the channels in a region between the channel base and the mutually facing ends of the transition regions, at which the first width dimension is measured, cannot contact the rear side of the second separator plate, which is usually not provided for in the prior art, or at least not to a comparable extent.

In particular, sections of the channel bottom and/or sections of the flanks directly adjacent to the channel base can also be pressed against the rear side of the second separator plate, at least in sections, as part of clastic deformation. This can take place during installation in and in particular during pressing of a bipolar plate stack of the electrochemical system. The extent of the elastic deformation that is possible in principle is determined by the thickness of an adjacent MEA and, in particular, by compensating for variations in the thickness of the MEA. In addition, there may still be elasticity reserves even after installation and grouting, for example to compensate for pressure differences. Previous weld seams can be completely eliminated or at least reduced and are exposed to less risk of damage due to the elasticity reserves.

A further development provides for the channel bottom of at least the first separator plate to be curved and for a rear region of the channel bottom of each channel to extend convexly in the direction of the second separator plate. In other words, a rear region of the channel bottom of each channel may extend convexly therefrom, i.e. from the channel bottom and/or the rear region, towards the second separator plate. A front region of the channel bottom can be curved to complement the rear region, i.e. it can be concave in particular.

The curvature can have a constant radius or a sectionally varying radius. As described above, the curvature can be mirror-symmetrical to the channel base. In particular, the channel base can be intersected by an axis of symmetry that runs in the depth direction and/or orthogonally to a plate plane of the bipolar plate.

The curved shape defines a reliable elastic deformability, for example through the possibility of elastic bending of the channel bottom into a flatter shape and/or in the direction of the second separator plate, in order to achieve the elasticity desired according to the present disclosure.

According to a further embodiment, at least the channels of the first separator plate, and more precisely: at least channels of the distribution region of the first separator plate, are elastically deformed at least in certain regions during pressing in a bipolar plate stack. Any clastic deformation of a duct as described herein may be accompanied by a change in the shape of the duct compared to the absence of deformation, in particular a change in the cross-sectional shape of the duct. In particular, the orientation of the flanks of the channel and/or curvatures or other shapes of a channel bottom can change as a result of the elastic deformation.

The separator plates are pre-stressed against each other due to the elastic deformation, at least in some regions, when installed. As a result, they can withstand varying pressures, particularly from any coolant that is conducted between the separator plates, at least partially and possibly without significant changes in shape.

In a further embodiment, the channels of at least the first separator plate, and more precisely: the channels in the at least one distribution region of the first separator plate under consideration, have an elasticity reserve for installation in the stack and pressing of the stack in the unassembled state. The channels can thus be elastically deformed during installation in the stack and pressing of the stack, which can be carried out according to known prior art solutions. However, depending on the dimensional accuracy of the MEAs or GDLs installed in a specific stack, it is not essential that the elasticity reserve is completely used up or even needed.

In a further development, the channel base of each channel of the second separator plate also contacts the back of the first separator plate when the bipolar plate is in an unassembled state in the stack. Optionally, in this case too, the first width dimension of each channel of the second separator plate is more than three times, optionally more than five times or more than six times, or even more than eight times, as large as the second width dimension. Here, the first and second width dimensions are defined analogously as disclosed for the channels of the first separator plate herein. In this way, the second separator plate can also be designed to be elastically deformable.

In this context, it may be provided that a ratio of the first and second width dimensions in the first separator plate is different from a corresponding ratio in the second separator plate. This allows the separator plates to be specifically adapted to the media to be conveyed.

According to a further development, the first transition region has a first transition point or also a first location at which the first transition region merges into a flank section which is curved differently from the first radius or which is curvature-free. Optionally, the first width dimension extends between the first transition points of the bilateral flanks. Accordingly, these first transition points can comprise or form the aforementioned mutually facing ends of the bilateral first transition regions.

In addition or alternatively, the first transition region has, for example, a second transition point at which a second section, for example a flank section, curved in accordance with the first radius, merges into the web. In particular, the web can be curved differently from the first radius or can also be curvature-free and/or define a plateau-like height level. The second transition points of the bilateral flanks can comprise or form ends of the first transition region that face away from each other.

In one embodiment, it is provided that the second width dimension is less than 1 mm, in particular less than 0.5 mm, in particular less than 0.3 mm and furthermore in particular less than 0.2 mm. This can mean that regions adjacent to the channel base, which may not contact the back of the second separator plate in the undeformed state, are comparatively large. In other words, the channel base can provide a rear contact region to the second separator plate that is, for example, small in size and/or point-like compared to the first width dimension, around which and/or relative to which the adjacent regions of the channel bottom can be elastically bent. Thus, the elastic deformability desired according to the present disclosure is reliably provided by means of a compact structure.

One embodiment further provides that, at least in the channels of the first separator plate under consideration, i.e. the channels of the distribution region of the first separator plate, the channel base is free from material bonding with the second separator plate. In particular, this can apply to all channels of the distribution region of the first separator plate and/or the entire distribution region can be free of such connections, in particular free of weld seams or spot welds. Outside the distribution region, however, material connections with the second separator plate can be provided in principle. By reducing or even completely eliminating the need for material-to-material connections, the risk of damage and, in particular, the risk of localized perforation of the separator plates in the event of pressure fluctuations is reduced accordingly.

According to a further development, the flanks each have a second radius in a second transition region to the channel bottom and a third width dimension of the channels extends between the second transition regions of the bilateral flanks. At least in the case of the first separator plate, the third width dimension is optionally at least half the size of the first width dimension and optionally at least three quarters of the first width dimension.

This means that the flanks take up a correspondingly reduced proportion of the total width of a channel, in particular a smaller proportion than the channel bottom. Due to its orientation relative to the plate plane, which is optionally less angled than the flanks, the latter is elastically more compliant than the flanks with respect to compressive loads orthogonal to the plate plane, such as those that can result from thickness variations of an MEA. By increasing the width of the channel bottom compared to the width of the flanks, the elastic flexibility of the channels can be increased.

In particular, the elastic compliance can be additionally increased in this context by the fact that, in the undeformed state, a rear region of the first separator plate in the second transition region and optionally the entire channel bottom between the second transition region and the channel base is spaced from the second separator plate.

The present disclosure also relates to a bipolar plate for an electrochemical system comprising a stack of a plurality of bipolar plates, the bipolar plate having a first separator plate and second separator plate whose rear sides face each other and whose front sides face away from each other, the first and second separator plates respectively:
at least two through-openings for passing a reaction medium through the respective separator plate;
and on their respective front sides: at least one distribution region and a flow field, the distribution region connecting one of the through openings to the flow field in a fluid-conducting manner;
a respective distribution region having channels for guiding one of the reaction media along a respective longitudinal axis of the channels, the channels being separated from one another by webs and each having a width extending parallel to a plate plane of the bipolar plate and orthogonal to the longitudinal axis of the channels,
each channel having a channel bottom and flanks on both sides of the respective channel bottom, which connect the channel bottom to a respective web,
whereby the channel bottom has a second radius on both sides in a second transition region to the respective flanks,
each channel having a third width dimension extending between the opposite ends of the second transition regions,
whereby at least in the case of the first separator plate, the channel bottom contacts the second separator plate on the rear side in sections even when the bipolar plate is unassembled in the stack,
characterized in that the channel bottom has a third radius at least in the middle 25% of its width, where the third radius is larger than the second radius.

Any explanation and further development of identical features provided herein also apply to the bipolar plate of this further aspect. This applies in particular to all variants relating to width dimensions and width ratios, insofar as they do not contradict the bipolar plate of this further aspect.

Optionally, the channel bottom has a third radius, which is larger than the second radius, at least in the middle 40% of its width.

The third radius is at least three times, optionally at least four times, optionally at least five times as large as the second radius. A large third radius improves the elasticity of the channel bottom.

The channel bottom can be evenly curved according to this third radius. The third radius of the channel bottom can be the radius of a curvature of the channel bottom in the direction of the second separator plate. The third radius can either merge directly into the two second radii on both sides, merge into the second radii via a section with constantly changing radii or continue in a straight section.

Exemplary embodiments of the present disclosure will be explained below with reference to the accompanying schematic figures. Similar reference symbols can be used for comparable features across all figures.

### BRIEF DESCRIPTION OF THE FIGURES

FIG. 1 shows an electrochemical system according to the present disclosure.

FIG. 2 shows a section of the electrochemical system from FIG. 1.

FIG. 3 shows a partial cross-sectional view of a bipolar plate according to an example of the prior art.

FIG. 4 shows a perspective view of the region of the bipolar plate shown in FIG. 3 and thus also relates to an example according to the prior art.

FIG. 5 shows a partial cross-sectional view of a bipolar plate according to an embodiment of the present disclosure.

FIG. 6 shows a perspective view of the region of the bipolar plate shown in FIG. 5.

FIG. 7 shows a partial cross-sectional view of a bipolar plate according to a further embodiment of the present disclosure.

FIG. 8 shows a perspective view of the region of the bipolar plate shown in FIG. 7.

FIG. 9 shows a partial cross-sectional view of a bipolar plate according to a further embodiment of the present disclosure.

FIG. 10 shows another partial cross-sectional view of the bipolar plate from FIG. 9.

FIG. 11 shows a perspective view of the region of the bipolar plate shown in FIGS. 9 and 10.

FIG. 12 shows exemplary spring characteristics for distribution regions of bipolar plates according to the present disclosure.

### DETAILED DESCRIPTION

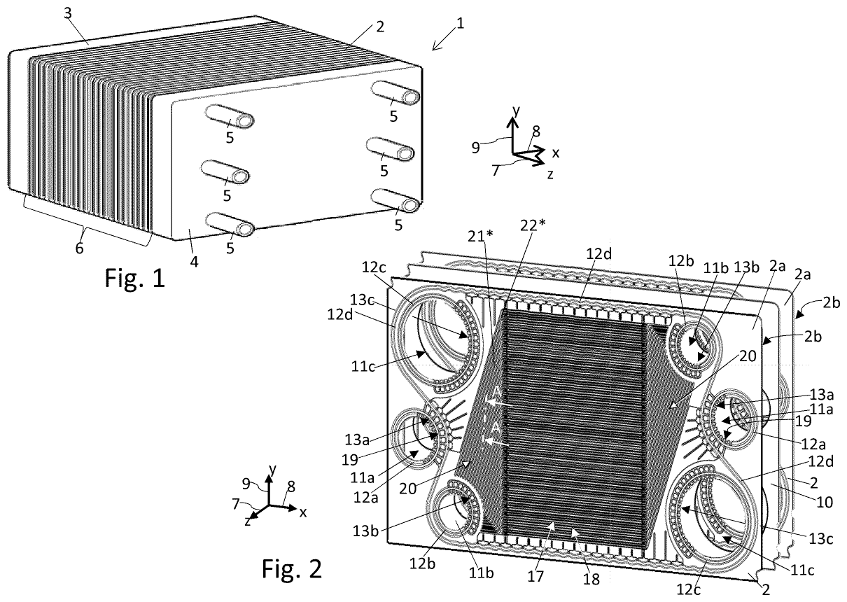

FIG. 1 shows an electrochemical system 1 comprising a plurality of structurally identical bipolar plates 2. The bipolar plates 2 are arranged as an assembly in a stack 6 and are stacked along a z-direction 7. The bipolar plates 2 of the stack 6 are clamped between two end plates 3, 4. The z-direction 7 is also called stacking direction. In the present example, the system 1 is a fuel cell stack. Each two adjacent bipolar plates 2 of the stack 6 therefore enclose between them an electrochemical cell, which serves for example to convert chemical energy into electrical energy. To form the electrochemical cells of system 1, a membrane electrode assembly (MEA) is arranged between adjacent bipolar plates 2 of stack 6 (see e.g. FIG. 2). Each MEA typically contains a membrane, for example an electrolyte membrane. Furthermore, a gas diffusion layer (GDL) may be arranged on one or both surfaces of the MEA.

Alternatively, the system 1 shown in FIGS. 1 and 2 may also be in the form of an electrolyser, an electrochemical compressor or a redox flow battery. Bipolar plates 2 can also be used in these electrochemical systems. The structure of these bipolar plates 2 can correspond to the structure of the bipolar plates 2 described in more detail here, even if the media fed onto or through the bipolar plates 2 in an electrolyzer, in an electrochemical compressor or in a redox flow battery may differ in each case from the media used for a fuel cell system.

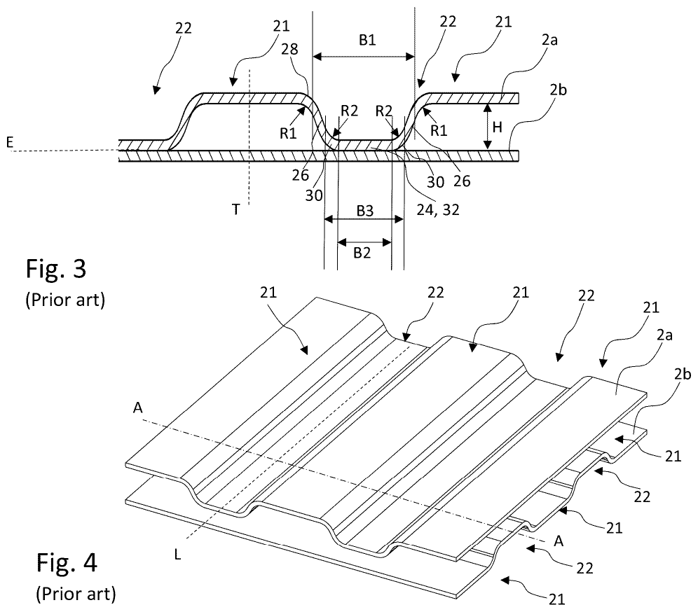

The z-axis 7 together with an x-axis 8 and a y-axis 9 defines a right-handed Cartesian coordinate system. The bipolar plates 2 each define a plate plane E (see FIG. 3), in which separator plates 2a, 2b (see FIG. 2), which form metallic layers of the bipolar plates 2, touch each other. The separator plates 2a, 2b also form their own plate plane in their non-formed regions, whereby the plate planes of both the bipolar plates 2 and the separator plates 2a, 2b are each aligned parallel to the x-y plane and thus perpendicular to the stacking direction or the z-axis 7. The end plate 4 comprises a plurality of media connections 5, via which media can be fed to the system 1 and via which media can be discharged from the system 1. Said media that can be supplied to the system 1 and discharged from the system 1 may comprise for example fuels such as molecular hydrogen or methanol, reaction gases such as air or oxygen, reaction products such as water vapour or depleted fuels, or, if necessary, coolants such as water and/or glycol. In the case of an electrolyser, water is supplied to the stack and oxygen and hydrogen are discharged therefrom.

FIG. 2 shows a perspective view of two adjacent bipolar plates 2 of the system 1 of FIG. 1 as well as a membrane electrode assembly (MEA) 10 arranged between these adjacent bipolar plates 2 and known in principle from the prior art. The MEA 10 in FIG. 2 is largely concealed by the bipolar plate 2 facing the viewer. The bipolar plate 2 is formed from two separator plates 2a, 2b that are joined together with a material bond, of which only the first separator plate 2a facing the viewer is visible over a large area in FIG. 2, the first separator plate 2a covering the second separator plate 2b. The separator plates 2a, 2b may each be manufactured from a metal sheet, for example from a stainless steel sheet or a sheet made of a titanium alloy. The sheets can be coated or clad in sections or over their entire surface, for example by means of a corrosion-inhibiting and/or conductivity-enhancing coating. The separator plates 2a, 2b can, for example, be connected to each other by a material bond, for example welded, soldered or glued, and can in particular be connected by laser welded joints. The MEA 10 has a frame-shaped reinforcing edge along its outer edge, on which the MEA is clamped fluid-tight between the two bipolar plates 2.

The separator plates 2a, 2b have through-openings, which are aligned with each other and form through-openings 11a-c of the bipolar plate 2. When stacking a plurality of bipolar plates of the type of bipolar plate 2, the through-openings 11a-c together with aligned through-openings in the reinforcing edges of the MEAs 10 form lines that extend through the stack 6 in the stacking direction 7 (see FIG. 1). Typically, each of the through-openings formed by the passage openings 11a-c is in fluid connection with one of the ports 5 in the end plate 4 of the system 1. By way of the lines formed by the through-openings 11a, it is possible for e.g. coolant to be introduced into the stack or discharged from the stack. In contrast, the lines formed by the through-openings 11b, 11c may be designed to supply fuel and reaction gas to the electrochemical cells of the fuel cell stack 6 of the system 1 and to discharge the reaction products from the stack 6. The media-guiding through-openings 11a-11c are each substantially parallel to the plate plane.

In order to seal off the through-openings 11a-c with respect to the interior of the stack 6 and with respect to the surrounding environment, the first separator plates 2a may each have sealing arrangements in the form of sealing beads 12a-c, which are arranged in each case around the through-openings 11a-c and in each case completely surround the through-openings 11a-c. On the rear side of the bipolar plates 2, facing away from the viewer of FIG. 2, the second separator plates 2b have corresponding scaling beads for sealing off the through-openings 11a-c (not shown).

In an electrochemically active region 18, the first separator plates 2a have, on the front side thereof facing towards the viewer of FIG. 2, a flow field 17 with structures (channels and webs) for guiding a reaction medium along the front side of the separator plate 2a. These structures are provided in FIG. 2 by a plurality of webs and channels, which run between the webs and which are delimited by the webs. On the front side of the bipolar plates 2 facing the viewer of FIG. 2, the first separator plates 2a also each have at least one distribution region 20, which, depending on the direction of flow, can also be referred to as a collection region in the manner described above. The distribution or collection region 20 comprises structures that are configured to distribute, over the active region 18, a medium that has been conveyed into the distribution or collection region 20 from a first of the two through-openings 11b, and/or to collect or pool a medium flowing from the active region 18 towards the second of the through-openings 11b. The distribution structures of the distribution or collection region 20 are also shown in FIG. 2 by webs 21 and channels 22 running between the webs 21 and delimited by the webs 21. In general, the elements 17, 18, 20 can therefore be interpreted as media-guiding embossed structures.

In a conventional bipolar plate, in the region of the bottoms of the channels in the distribution regions, the separator plates lie directly on top of each other and are supported against each other. The two separator plates are usually connected to each other, in particular welded, at contact points in the distribution regions.

The sealing beads 12a-12c of the example in FIG. 2 have feedthroughs 13a-13c, which are used for the passage of media through the sealing beads. For example, the feedthroughs 13a allow coolant to pass between the through-opening 12a and the distribution region 20, so that the coolant enters or is led out of the distribution region between the separator plates 2a, 2b. Furthermore, the feedthroughs 13b allow the passage of hydrogen between the through-opening 12b and the distribution region 20 on the upper side of the separator plate 2a. The passages 13c enable air, for example, to pass between the through-opening 12c and the distribution region 20, so that air enters the distribution region 20 on the underside of the lower separator plate 2b and is guided out from this distribution region 20. The through-openings 11a or the lines through the plate stack of the system 1 that are formed by the through-openings 11a are in each case fluidically connected to each other via a cavity 19 which is enclosed by the separator plates 2a, 2b. If necessary, this cavity 19 can serve to guide a coolant through the bipolar plate 2, in particular in order to cool the electrochemically active region 18 of the bipolar plate 2.

The first separator plates 2a of the bipolar plates 2 of the stack 6 also each have a further sealing arrangement in the form of a perimeter bead 12d, which surrounds the flow field 17 of the active region 18, the distribution or collection region 20 and the through-openings 11b, 11c and seals these from the through-opening 11a, i.e. from the coolant circuit, i.e. to the coolant circuit, and to the environment of the system 1. The second separator plates 2b each comprise corresponding perimeter beads 12d. In alternative plate designs, the perimeter bead may also enclose the coolant openings and thus the entire coolant circuit. The structures of the active region 18, the webs 21 and channels 22 of the distribution or collection region 20 and the sealing beads 12a-d are each formed in one piece with the separator plates 2a and molded into the separator plates 2a, e.g. in an embossing, deep-drawing or hydroforming process. The same applies to the corresponding distribution structures and sealing beads of the second separator plates 2b.

Particularly in the case of a fuel cell, the separator plates 2a, 2b of the bipolar plate 2 may each be formed, for example, from a stainless steel sheet having a thickness of less than 100 μm. In the case of an electrolyser, it is possible to use either sheets made of a titanium alloy or sheets made of fully-coated stainless steel. The sheet thicknesses are usually greater in electrolyzers; for example, they can be 100-800 μm, 150-500 μm, in particular 200-300 μm. The bipolar plate 2 usually has a substantially rectangular shape, but it may also be round or oval, particularly in the case of electrolyzers.

FIG. 2 shows an exemplary layer of a sectional plane A-A. The sectional plane A-A is generally orthogonal to the plate plane E of the bipolar plate 2 shown in FIG. 3 and in one of the distribution regions 20 of the first separator plate 2a. Furthermore, it runs in a region in which a distribution region 20 of the second separator plate 2b that faces away from the viewer in FIG. 2 also extends. This means that the left-hand distribution regions 20 of the separator plates 2a, 2b from FIG. 2 overlap in the sectional plane A-A. In addition, the rear sides or inner sides of the separator plates 2a, 2b, which are shaped to complement the respective distribution regions 20, are also opposite each other there.

FIG. 3 shows a partial cross-sectional view of a bipolar plate 2, which in principle is designed in the same way as the bipolar plate 2 shown in FIG. 2, but has distribution regions 20 formed in accordance with the prior art. The cross-sectional plane is analogous to the sectional plane A-A in FIG. 2. FIG. 4 shows a perspective view of the sectioned region shown in FIG. 3.

It can be seen in particular from FIG. 4 that the sectional plane A-A runs along the rear side of a channel 22 of the second separator plate 2b, so that the latter is essentially shown in a straight line in FIG. 3. For the first separator plate 2b, however, at least sections of second channels 22 and webs 21 positioned between them can be seen in FIG. 3. A longitudinal channel axis L (see FIG. 4) is perpendicular to the sheet plane of FIG. 3. The separator plates 2a, 2b touch each other along the plate plane E of the bipolar plate 2 shown in FIG. 3.

The webs 21 are designed as level high plateaus. The channels 22 have flat channel bottoms 24, which form low plateaus that extend parallel to the high plateaus of the webs 21. The depth and height dimensions each refer to a depth axis T that is orthogonal to the plate plane E. A distance H between the webs 21 and the channel bottoms 24 along the depth axis T is shown.

The channel bottoms 24 are each connected to an adjacent web 21 via bilateral flanks 26. The channel bottoms 24, which are flat and also have corresponding flat rear sides, each rest on the rear side of the opposite inner side of the second separator plate 2b. In this contact region, weld seams (not shown) can be provided for connecting the separator plate 2a, 2b.

The separator plates 2a, 2b are relatively rigidly connected to each other due to the large contact surfaces surrounding the rear of the channel bottoms 24 and the weld seams provided there. The clastic deformation capacity, particularly along the depth axis T, is therefore correspondingly low.

In a first transition region 28, the flanks 26 each merge with a first radius R1 into a directly adjacent web 21. In a second transition region 30, the flanks 26 each merge with an oppositely curved radius R2 into a directly adjacent channel bottom 24.

FIG. 3 also shows various width dimensions for one of the channels 22, which also apply to the other channels 22 of the distribution region 20 of the first separator plate 2a and are provided analogously in the embodiments of the present disclosure described below.

A first width dimension B1 relates to a width dimension of the channel 22 in the first transition region 28. More precisely, those ends of the bilateral transition regions 28 of a channel 22 are considered at which the radius R1 changes into a rectilinear flank section or, in other words, a rectilinear flank section is present for the first time. If there is no such straight edge section, the edge 26 has an inflection point as expected (not shown), at which, for example, a curvature changes between the radii R1, R2. In this case, the first width dimension B1 can be measured between the turning points of the bilateral flanks 26 of a respective channel 22.

A further width dimension, which corresponds to a second width dimension B2 described below, indicates a width of a channel base 32. The channel base 32 is that region of the channel bottom 24 which touches the other separator plate 2b at the rear and/or which forms a deepest region of the channel 22 along the depth axis T. In the prior art example shown, these width dimensions B2 correspond to the width of the channel bottom 24 minus the width regions in which the radii R2 extend, due to the flat shape of the channel base 32.

In the previously known example of FIGS. 3 and 4, the first width dimension B1 is no more than twice as large as the second width dimension B2.

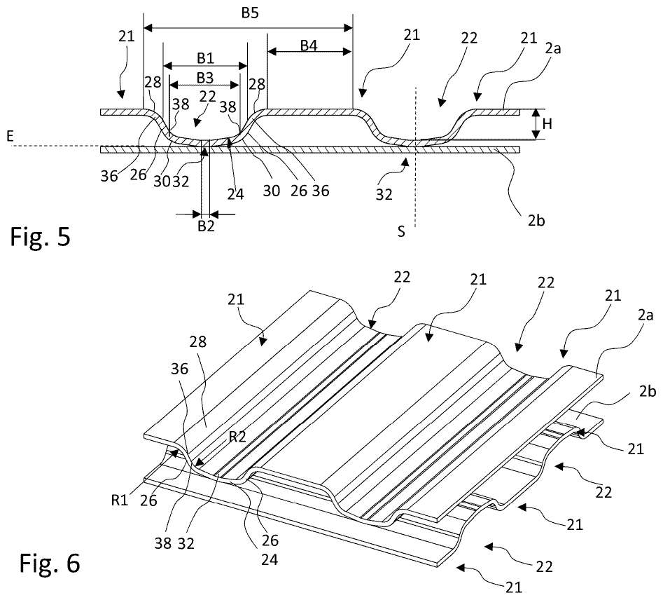

FIG. 5 shows a cross-sectional view analogous to FIG. 3, but for an example according to the present disclosure. FIG. 6 is a perspective view of the example in FIG. 5.

In this example according to the present disclosure, the channel bottom 24 of the first separator plate 2a is curved. More precisely, its rear side extends convexly outwards in the direction of the second separator plate 2b. A channel base 32 forms a deepest region within the channel bottom 24 and touches the rear side of the second separator plate 2b. The channel base 32 is intersected by an axis of symmetry S, in relation to which the curvature of the channel bottom 24 is mirror-symmetrical.

A plate plane E is entered, which coincides with a plane tangential to the rear of the channel base 32. The latter plane runs parallel to the high plateau-like outer sides of the webs 21.

In this case, a second width dimension B2 does not extend along the entire section between the mutually facing ends of the radii R2 as explained with respect to FIG. 3, but only includes the channel base 32, which is less wide than the channel bottom 24 and than this section. The sections of the channel bottom 24 adjacent to the channel base 32 are spaced from the second separator plate 2b at the rear.

A first width dimension B1 again extends between the first transition regions 28, between the flanks 26 and webs 21. Once again, the first transition points 36 marked as examples in FIG. 5 are considered, at which straight sections of the flanks 26 begin from the perspective of the adjacent webs 21, see also FIG. 6.

FIG. 5 also shows a third width dimension B3, which essentially corresponds to a width dimension of the channel bottom 24. More precisely, the width dimension B3 in the example shown extends between exemplarily marked second transition points 38, at which a channel region curved according to the radius R2 merges into the flanks 26.

FIG. 5 shows that the first width dimension B1 is greater than the second width dimension B2 and also the third width dimension B3. More precisely, it is approximately ten times as large as the second width dimension B2 and at least 1.33 times as large as the third width dimension B3. For example, the first width dimension B1 is approx. 1.025 mm and the second width dimension B2 is approx. 0.1 mm.

For the sake of completeness, further width dimensions B4 and B5 are also shown in FIG. 5. The width dimension B4 relates to a web width of, for example, 1.04 mm and the width dimension B5 relates to a composite web-channel width of, for example, 2.54 mm.

The bipolar plate 2 in FIGS. 4 and 5 is in an unassembled state and yet the separator plates 2a, 2b are already in contact here. However, these are not welded together within their distribution regions 20. Instead, they lie against each other while retaining an elastic deformation reserve. In particular, the channel bottom 24 provides such an elastic deformation reserve, for example by being pressed closer in the direction of and possibly into rear contact with the second separator plate 2b in accordance with the thickness tolerances of an MEA when pressing a stack 6 of bipolar plates 2 (see FIG. 1).

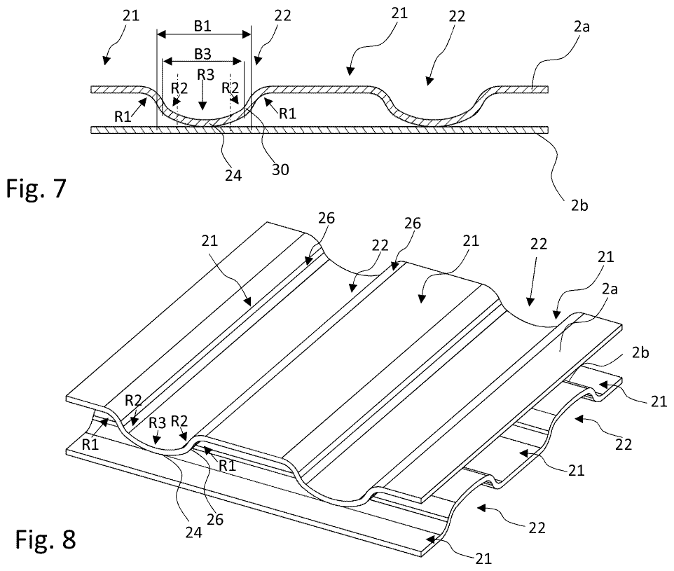

For a further embodiment of the present disclosure, FIG. 7 is a cross-sectional view analogous to FIG. 3 and FIG. 5. Furthermore, FIG. 8 is a perspective view analogous to FIG. 4 and FIG. 6.

In this further embodiment example, the channel bottom 24 is provided with a radius R3, the embodiment example has no explicit channel base 32. Rather, the separator plate 2a is in contact with the separator plate 2b in a point-shaped cross-section in the uncompressed state, and in a linear shape in the course of the channel 22. The three radii R2, R3 and R2 converge along the course of the channel bottom 24. The radius R3 extends approximately over the middle ⅔ of the width B3, as indicated by the dotted lines. In this embodiment, the radius R3 is approximately 3.5 times as large as the radii R2. The large radius, which extends over a large part of the width of the channel bottom 24, gives it additional elasticity. Thus, while the example of FIGS. 5 and 6 has a trapezoidal channel bottom 24, the channel bottom 24 of the example of FIGS. 7 and 8 is rounded. The advantages are similar to those described for the example in FIGS. 5 and 6.

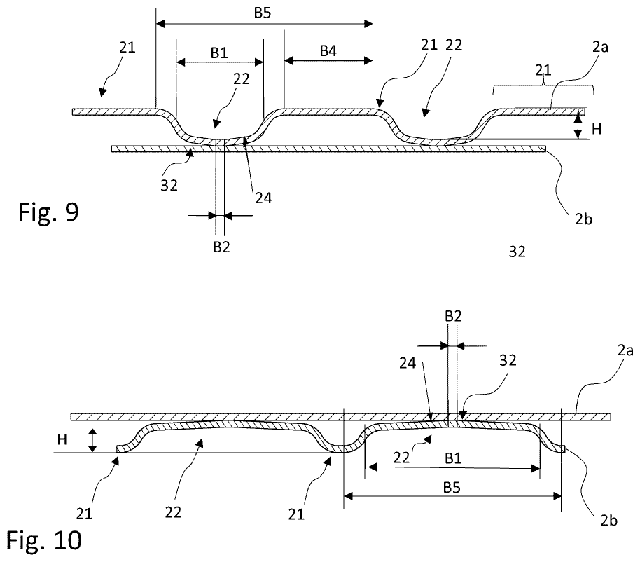

FIGS. 9-11 show a further embodiment of the present disclosure. The first and second separator plates 2a, 2b are clearly different from each other in terms of their channel web structures in the respective distribution regions 20, in particular with regard to the first width dimensions B1 of the respective channels 22.

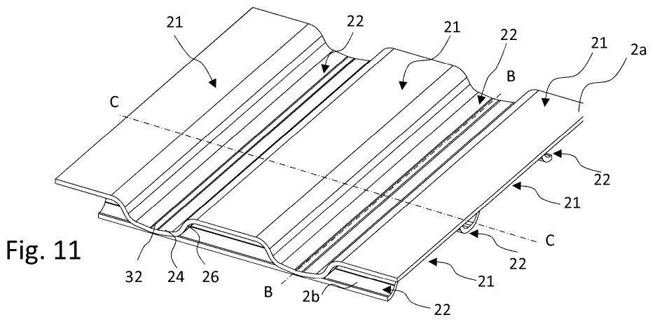

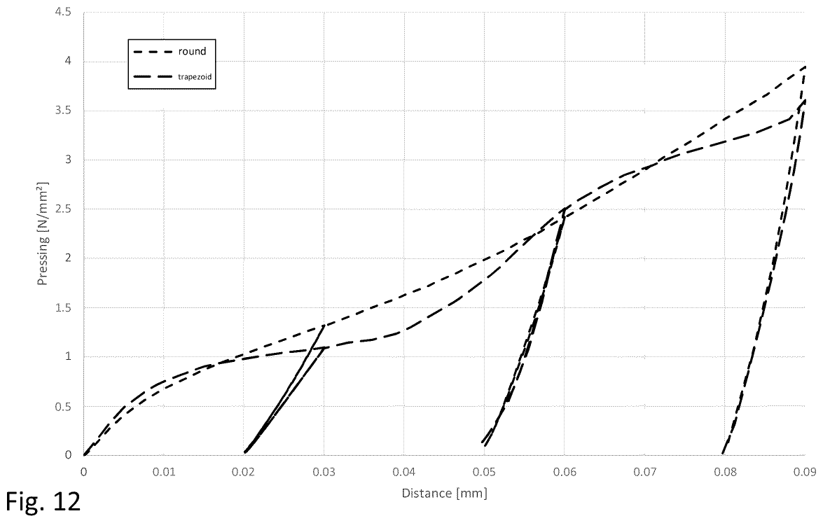

FIG. 9 shows a cross-sectional view containing the sectional axis C-C from the perspective view of FIG. 11. FIG. 10 shows a cross-sectional view containing the sectional axis B-B from the perspective view of FIG. 11. The cross-sectional view in FIG. 9 essentially corresponds to that in FIG. 5, so please refer to the description there.

The cross-sectional view of FIG. 10 shows the width ratios of the web-channel structure of the second separator plate 2b. The width dimensions B1, B2, B5 shown are defined for the first separator plate 2a analogous to the example in FIG. 9 and FIG. 5. It can be seen that the first width dimension B1 exceeds the second width dimension B2 even more clearly than in the case of FIG. 9. More precisely, the first width dimension B1 is 1.95 mm and the second width dimension B2 is 0.1 mm, so that the first width dimension B1 is essentially twenty times as large as the second width dimension B2.

FIG. 12 shows an example of the spring characteristics of the bipolar plates 2 with a rounded channel bottom 24 as shown in FIG. 7 (short dashed characteristic curve) and with a trapezoidal channel bottom 24 as shown in FIG. 5 (long dashed characteristic curve). The distribution regions 20 of the two exemplary bipolar plates 2 are each initially compressed by 0.03 mm and then relieved, in each case springing back by approx. 0.01 mm. They therefore have a plastic and an elastic compression component. If they are pressed again to the previously achieved maximum of 0.03 mm, i.e. by 0.01 mm, no additional plastic deformation occurs within this pressing range. Plastic deformation only occurs again in addition to clastic deformation when the total compression exceeds 0.03 mm. For the two springbacks with a maximum compression of 0.06 and 0.09 mm, it can be seen that the plastic deformation proportion is approx. ⅔ in each case, while the elastic deformation proportion is only approx. ⅓. At first glance, this may appear to be a very high plastic component, but what is important here is that there is a significant elastic deformation component which, even after plastic deformation to compensate for tolerances for very thin MEAs or GDLs, enables sufficient elastic recovery and thus reaction to pulsations of the media, especially the coolant. The comparison of the two spring characteristic curves also shows that the bipolar plate 2 with rounded channel bottom 24 can absorb slightly more force than the bipolar plate 2 with trapezoidal channel bottom 24 for the same deformation over large regions.

1. A bipolar plate for an electrochemical system comprising a stack of a plurality of bipolar plates, the bipolar plate having a first separator plate and a second separator plate whose backsides face each other and whose front sides face away from each other, the first separator plate and the second separator plate respectively having:
at least two through-openings for passing a reaction medium through the respective separator plate;
and on their respective front sides: at least one distribution region and a flow field, the distribution region connecting one of the at least two through openings to the flow field in a fluid-conducting manner;
wherein a respective distribution region has channels for guiding the reaction medium along a respective longitudinal channel axis (L), wherein the channels are separated from one another by webs and each have a width extending parallel to a plate plane (E) of the bipolar plate and orthogonal to the longitudinal channel axis (L),
wherein each channel has a channel bottom with a channel base and has flanks on both sides of the channel bottom, which connect the channel base to a respective web,
wherein the flanks have a first radius (R1) in a first transition region to the respective web,
wherein each channel has a first width dimension (B1) extending between ends of the first transition regions of the flanks that face each other, and a second width dimension (B2) indicating a width of the channel base,
wherein at least in the first separator plate, the channel base contacts the back of the second separator plate in an unassembled state of the bipolar plate in the stack, and
wherein, at least in the first separator plate, the first width dimension (B1) is more than three times as large as the second width dimension (B2).

2. The bipolar plate according to claim 1, wherein the channel bottom of at least the first separator plate is curved and a rear region of the channel bottom of each channel thereby extends convexly in a direction of the second separator plate.

3. The bipolar plate according to claim 1, wherein at least the channels of the first separator plate in the unassembled state in the stack have an elasticity reserve for installation in the stack and pressing of the stack.

4. The bipolar plate according to claim 1, wherein the channel base of each channel of the second separator plate also contacts the back of the first separator plate in the unassembled state of the bipolar plate in the stack, and the first width dimension (B2) of each channel of the second separator plate is more than three times as large as the second width dimension (B2).

5. The bipolar plate according to claim 4, wherein a ratio of the first width dimension (B1) and the second width dimension (B2) in the first separator plate is different from a corresponding ratio in the second separator plate.

6. The bipolar plate according to claim 1, wherein the first transition region has a first transition point at which the first transition region merges into a flank section that is curved in a different manner from the first radius (R1) or which is free of curvature, the first width dimension (B1) extending between the first transition points of the flanks that face each other.

7. The bipolar plate according to claim 1, wherein the second width dimension (B2) is less than 1 mm.

8. The bipolar plate according to claim 1, wherein, at least in the channels of the first separator plate, the channel base is in each case free from material bonding with the second separator plate.

9. The bipolar plate according to claim 1, wherein the flanks each have a second radius (R2) in a second transition region to the channel bottom and a third width dimension (B3) of the channels extends between the second transition regions of the flanks that face each other, the third width dimension (B3) of at least the first separator plate being at least half as large as the first width dimension (B1).

10. The bipolar plate according to claim 9, wherein a rear region of the first separator plate is spaced apart from the second separator plate in the second transition region.

11. A bipolar plate for an electrochemical system comprising a stack of a plurality of bipolar plates, the bipolar plate having a first separator plate and a second separator plate whose backsides face each other and whose front sides face away from each other, the first separator plate and the second separator plate respectively having:
at least two through-openings for passing a reaction medium through the respective separator plate;
and on their respective front sides: at least one distribution region and a flow field, the distribution region connecting one of the at least two through openings to the flow field in a fluid-conducting manner;
wherein a respective distribution region has channels for guiding the reaction medium along a respective longitudinal channel axis (L), wherein the channels are separated from one another by webs and each have a width extending parallel to a plate plane (E) of the bipolar plate and orthogonal to the longitudinal channel axis (L),
wherein each channel has a channel bottom and has flanks on both sides of the channel bottom, which connect the channel bottom to a respective web, wherein the channel bottom has a second radius (R2) on both sides to the respective flanks in a second transition region,
wherein each channel has a third width dimension (B3) extending between opposite ends of the second transition regions,
wherein, at least in the case of the first separator plate, the channel bottom contacts the second separator plate on the rear side in sections in an unassembled state of the bipolar plate in the stack, and
wherein the channel bottom has a third radius (R3) at least in a middle 25% of the third width dimension (B3),
where the third radius (R3) is larger than the second radius (R2).

12. The bipolar plate according to claim 11, wherein the third radius (R3) at least in a middle 40% of the third width dimension (B3) is larger than the second radius (R2).

13. The bipolar plate according to claim 11, wherein the third radius (R3) is at least three times as large as the second radius (R2).
